(19) United States
(12) Patent Application Publication
(10) Pub. No.: US 2013/0233916 A1
(43) Pub. Date: Sep. 12, 2013

(54) METHOD AND SYSTEM FOR DATA MANAGEMENT USING QR CODES

(71) Applicant: Minh-Duc Tran, Springfield, VA (US)

(72) Inventor: Minh-Duc Tran, Springfield, VA (US)

(21) Appl. No.: 13/558,326

(22) Filed: Jul. 25, 2012

Related U.S. Application Data
(60) Provisional application No. 61/572,885, filed on Jul. 25, 2011.

(51) Int. Cl. G06F 17/30; G06K 7/14; G06K 19/06

(52) U.S. Cl. CPC G06F 17/30; G06K 19/06037; G06K 7/1417
USPC 235/375

(57) ABSTRACT

A method of using a two-dimensional barcode having a first data field and a second data field which includes receiving registration information from a location, assigning the location a unique identification, receiving a greeting information corresponding to the location and the unique identification, storing the registration information, the location, the unique identification and the corresponding greeting information within a storage device, capturing data from a two-dimensional barcode using an electronic device, initiating a software program identified within the first data field of the captured two-dimensional barcode and using the identified software program to execute commands within the second data field of the captured two-dimensional barcode.

### CROSS-REFERENCE TO RELATED APPLICATIONS

This application claims the benefit of U.S. Provisional Patent Application No. 61/572,885, filed on Jul. 25, 2012, the disclosure of which is incorporated herein in its entirety by reference.

### BACKGROUND OF THE INVENTION:

### 1. Field of the Invention

The present general inventive concept relates to a method of managing data using a captured image, and more particularly to a method of managing data using a captured two-dimensional bar code.

Several method and systems currently exist which capture data from 2-dimensional barcodes, such as QR Codes. However, these methods merely link a user to an encoded website URL. Also, conventional methods of encoding data within a QR code only provides capacity to store a small amount of data within the QR code and only encodes instructions for a browser to open and view an encoded website URL content.

That is, while these and other prior art methods may be suitable for their intended applications, none of them solve the various problems addressed by the present invention.

### BRIEF SUMMARY OF THE INVENTION

The present general inventive concept provides a method which directs an application or specific software stored on a device to read and interpret a specifically formatted QR code, to interact with a database and/or server, to provide access to large amounts of data, and to directly download and store data from the server onto the device.

The present invention allows the QR code to be encoded with a greater amount of data.

Additional aspects and utilities of the present general inventive concept will be set forth in part in the description which follows and, in part, will be obvious from the description, or may be learned by practice of the general inventive concept.

Features and/or utilities of the present general inventive concept provide method for managing data using two-dimensional barcodes which includes capturing two-dimensional barcode data having a predetermined format, the predetermined format having a first data field, a second data field, and a third data field, initiating a software program identified in the first data field, and accessing a server identified in the second data field using data within the third data field.

The third data field may include at least one of an account identification code, a computer readable code, a user identification code, and a user password.

Features and/or utilities of the present general inventive concept also provide method for using a two-dimensional barcode having a first data field and a second data field which includes receiving registration information from a location, assigning the location a unique identification, receiving a greeting information corresponding to the location and the unique identification, storing the registration information, the location, the unique identification and the corresponding greeting information within a storage device, capturing data from a two-dimensional barcode using an electronic device, initiating a software program identified within the first data field of the captured two-dimensional barcode, and using the identified software program to execute commands within the second data field of the captured two-dimensional barcode.

The two-dimensional barcode may be physically located at the location.

The commands may include retrieving the greeting information corresponding to the unique identification identified within the second data field from the storage device.

The commands may further include displaying the greeting information on the electronic device.

Features and/or utilities of the present general inventive concept also provide method of using a two-dimensional barcode having a plurality of data fields which includes receiving a user registration information from a user, storing the user registration information within a first storage device, receiving a product identification information of a product including a unique identification, storing the product identification information within a second storage device, capturing data from a two-dimensional barcode corresponding to a desired product using an electronic device, initiating a software program identified within a first data field of the plurality of data fields, using the identified software program to retrieve the product identification information from the second storage device corresponding to the unique identification identified within a second data field of the plurality of data fields and displaying the product identification information corresponding to the desired product on the electronic device.

The two-dimensional barcode may be physically located on the product.

Features and/or utilities of the present general inventive concept also provide a method for managing data using two-dimensional barcodes which includes capturing two-dimensional barcode data having a predetermined format using a specific software on a mobile device, the predetermined format having a first data field, a second data field, and a third data field, the first data field defining a first URL address, wherein the specific software stores a plurality of redirect addresses, each redirect address having a table of conditions and retrieving data using a redirect address if data within the two-dimensional barcode data matches data within the table of conditions corresponding to the redirect address.

The specific software may retrieve data from a first redirect address stored on the mobile device when data within the two-dimensional barcode data satisfy the conditions corresponding to the first redirect address defined within the table of conditions.

### BRIEF DESCRIPTION OF THE DRAWINGS

These and/or other utilities and advantages of the present general inventive concept will become apparent and more readily appreciated from the following description of the embodiments, taken in conjunction with the accompanying drawings of which:

FIG. 1 is a screen shot of a specific software scanning, reading, and interpreting a QR code having user registration information;

FIG. 2 is a flow chart illustrating an exemplary embodiment of a method according to the present general inventive concept;

FIG. 3 is a flow chart illustrating another exemplary embodiment of a method according to the present general inventive concept; and

FIG. 4 is a flow chart illustrating another exemplary embodiment of a method according to the present general inventive concept.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

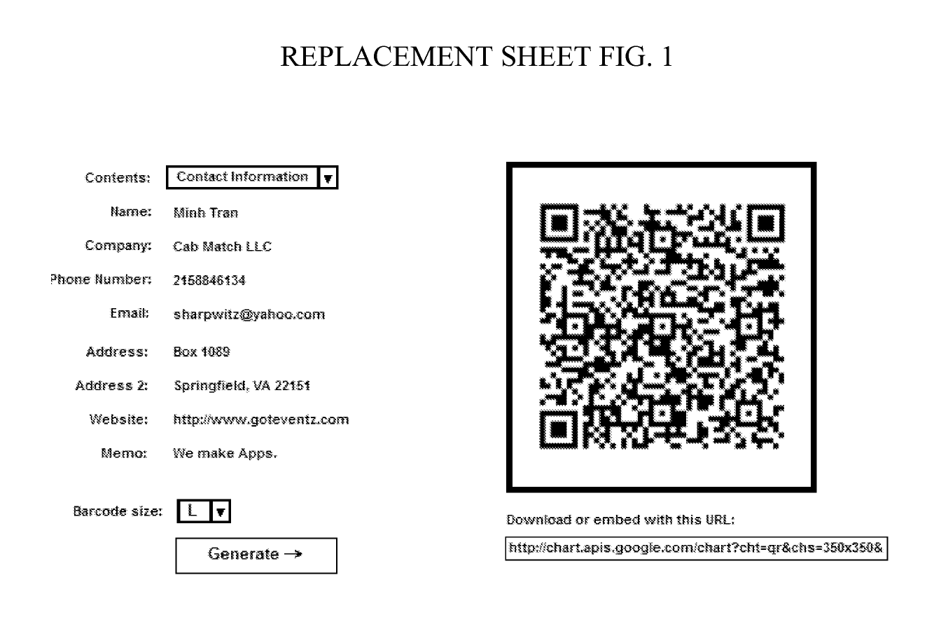

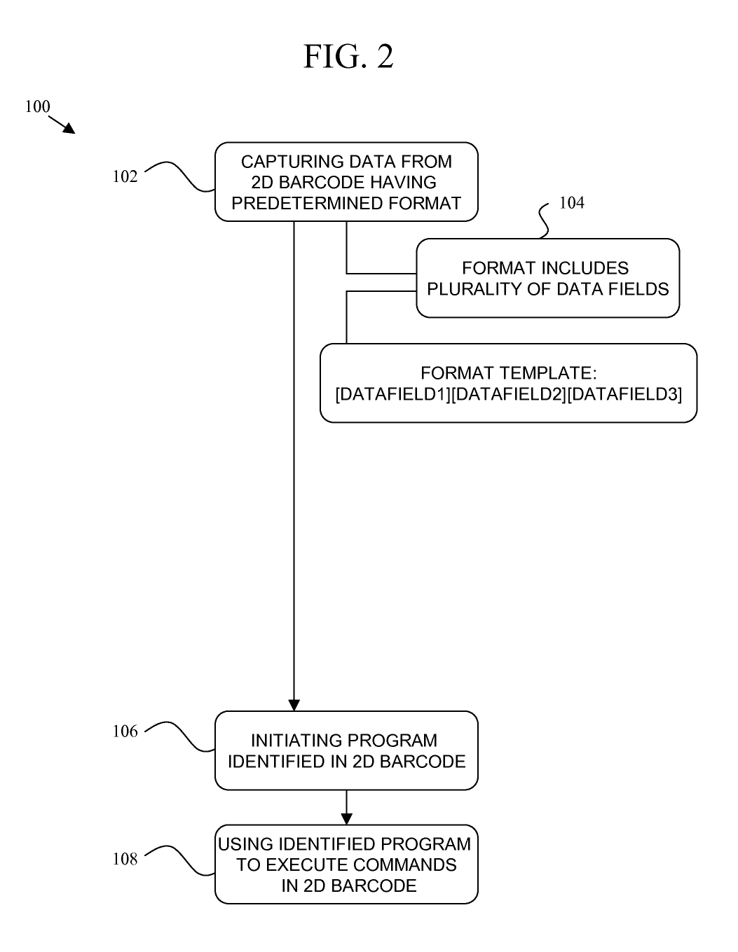

FIG. 1 is a screen shot of a specific software scanning, reading, and interpreting a QR code having user registration information. FIG. 2 is a flow chart illustrating an exemplary embodiment of a method according to the present general inventive concept.

An exemplary embodiment of the present general inventive concept provides a method for managing data using a pattern within two-dimensional barcodes. A two-dimensional barcode is a graphical image that stores information both horizontally, as in typical barcodes, and vertically. As a result, two-dimensional barcodes can store up to 7,089 characters, which is significantly greater storage than is possible with the 20-character capacity of a unidimensional barcode.

Referring to FIG. 2, the method 100 according to the present invention includes capturing two-dimensional barcode data 102 having a predetermined format. The format of the data which is encoded as a two-dimensional barcode includes a plurality of data fields 104. A first data field (i.e. datafield1) of the plurality of data fields may be used to identify a software which is to be used and a second data field (i.e. datafield2) may contains commands or instructions which are to be executed by the identified software. However, the present general inventive concept is not limited thereto. That is, the format may also include a third data field (i.e. datafield3) as required.

The method 100 further includes using a specific software on a device to read and interpret the data fields of the two-dimensional barcode 102, initiating a second software or the same specific software identified within a data field of the two-dimensional barcode 106, and using the identified software to execute commands within the two-dimensional barcode 108.

For instance, in an exemplary embodiment, a two-dimensional bar code, such as a Quick Response Code (QR code) is first formatted to include a unique sequence or pattern of words, letters, phrases, numbers, characters, and/or symbols that can be read and interpreted by a specialized software on an electronic device. After scanning and capturing the QR code data, the specialized software would recognize the unique sequence and perform a specific action according to that sequence.

Examples of the unique sequence may include (1) 123cdfer345; (2) 1010101000 ::0001:::01010010; (3) GEX$̂@; (4) 20897,softwarename, new greeting message to customer; and (5) goteventz.com,url,http://www.goteventz.com.

In particular, the specialized software on the electronic device used to capture the QR code having a predetermined format, can recognize and execute specific commands encoded within the QR code. As such, if the predetermined format was “login:abc,password:456,url:http://www.goteventz.com,marketingcampaign”, the specialized software would login user “abc” into the website www.goteventz.com” using the password “456.” That is, the QR code data and plain text (encoded within the QR code) may be used to represent an account identification code or a user registration information. Thus, when the QR code is read and interpreted by a specific software program on a device, the user registration information may be extracted by the program and used to communicate with a server to establish open data communication between the server and the device used. However, the present general inventive concept is not limited thereto. That is, in alternative embodiments, the specific software may store a user's login information on the device and only when a particular QR code is scanned and interpreted, the software may use the stored login information to load a different web link using the stored login information to login into a server. For instance, the QR encoded data may have the following formats

“https://biztoqr.com/login?name=abcd&password=def”or

“http://cardswapp.com/login?name=abcd&password=def”

Wherein, user name “abcd” would be logged into a server using password “def” when the specific software is used to read and interpret a QR code, according to an exemplary embodiment of the present invention.

Current methods of encoding data within a QR code only includes a single command such as “sms:7034567890”, whereas the method according to the present inventive includes multiple commands to be interpreted and executed by the specific software on a device.

For example, an application of the method according to the present invention may include a patient wearing a QR code having his or her specific user registration information encoded therein. A hospital may use a device having a specific program to read, interpret, and execute commands embedded within the patients QR code. The QR may include a format such as patient123CAN345,softwarename, wherein when scanned, the caretaker would instantly become aware of the patient's user registration information, type of medical condition, software required to execute specific commands, as well as a particular code “345” which may be used to indicate what procedure or treatment the doctors have prescribed for that patient.

In alternative embodiments, the predetermined format may include a third data field which identifies a server from which the identified (specialized) software manages data. The third data field may include at least one of an account identification code, a computer readable code, a user identification code, and a user password. However, the present general inventive concept is not limited thereto. That is, the QR code may also include a specific sequence of letters, numbers, and symbols to represent a special key that can be used by a specific software on a device to unlock features on the device that were not readily available until the specific sequence was scanned and interpreted.

In further embodiments, the QR code may include a software designation data field which identifies the specific software required to interpret the QR code and to execute commands and/or instructions within the QR code. For instance, the QR code may include a specific sequence corresponding to each specific software to identify which software is required.

In yet further embodiments, the QR code may also represent a user registration information including a user login and a user password which can be used by the specific software to login the user into a server and allow a download, transfer, and access to a predetermined server within the software or a server identified within the QR code.

FIG. 1 is a screen shot of a specific software scanning, reading, and interpreting a QR code having user registration information.

In an alternative embodiments, the present general inventive concept also provides a method for using a web URL retrieved from a QR code as a key to login into a database. The database may be predefined by the creator of the QR code. The specialized software is used to interpret the web URL as including a login name, password, server location, and download instructions. However, conventional software used to read QR code would interpret the same web URL as merely a link to display web content. The method according to the present invention requires formatting the data which is to be encoded as a QR code to include data having a specific pattern. For example, the data may be “https://biztogr.com/index/view/id/4f21e1bf9c7684df6c000”. That is, conventional QR reading software would interpret this data as merely a link to a website, disregarding the “4f21e1bf9c7684df6c000” portion. However, conversely, the specialized software used in the present invention would read and interpret a pattern within the “4f21e1bf9c7684df6c000” portion as including a user login information and the user is directly logged into the specified database or server defined within the “4f21e1bf9c7684df6c000” portion.

Another exemplary embodiment of the present general inventive concept provides a method for transferring business card information between two users. (i.e. a first user and a second user). Both the first and second user would store their user registration information within a server or other storage device. (i.e. a first storage device). The user registration information may include the users name, address, email address, telephone number, website, and any other additional information. The server may then assign each user with a unique user identification ID and a QR code having their unique user identification ID and plain text. The users may print and display their specific QR codes on their business materials or devices, including business cards, smart phone screens, printed media, multimedia or any other media which can display the QR code.

Due to the limit on data encoded within typical QR codes, the conventional methods of retrieving contact information from a text string is limited. In an exemplary embodiment of the present invention, the specific software on a device may be used to read a QR code which allows the device to download an unlimited amount of data. That is, the QR code is encoded with a predefined pattern which instructs the specific software to download data, such as contact information, from a particular server or database.

Referring to FIG. 1, the specific software may be used to scan, read, and interpret the user's QR code and recording the data within the user's device. That is, when the first user scan's the QR code of the second user, the specific software on the first user's electronic device can read the second user's QR code as including his name, company, phone number, email, address, website, and memo and then stores this information within a memory of the first user's electronic device.

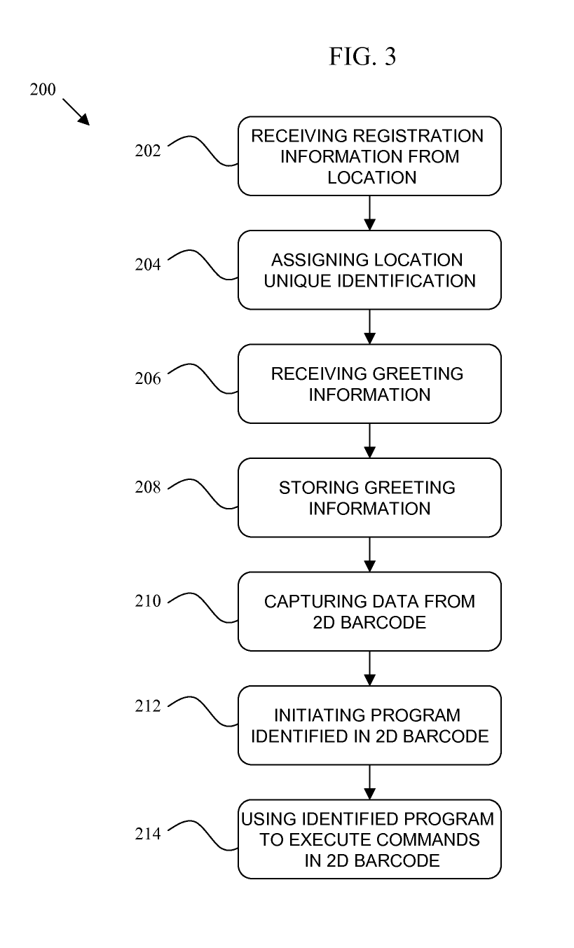

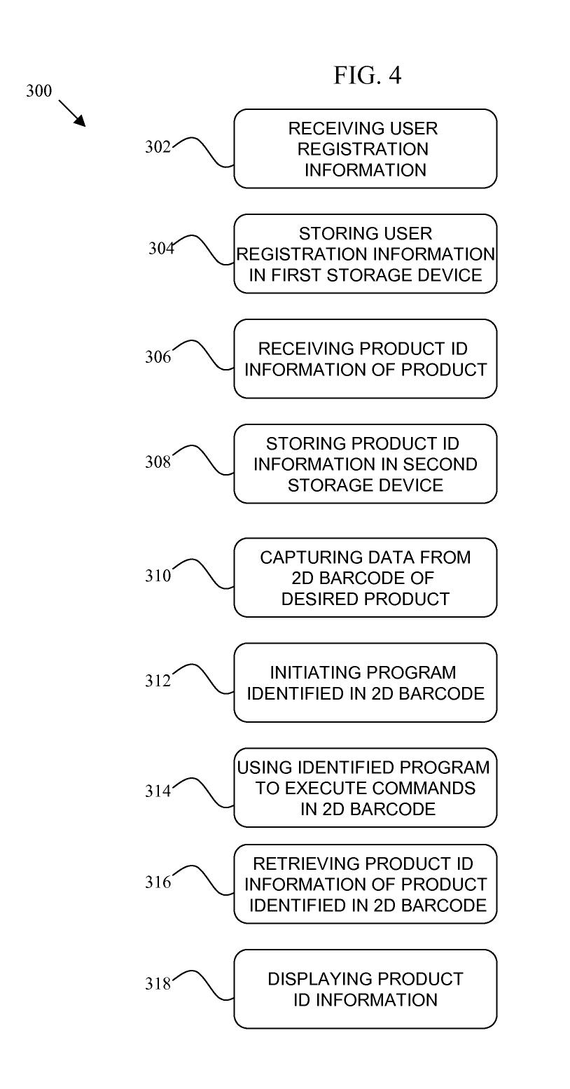

FIG. 3 is a flow chart illustrating an exemplary embodiment of a method 200 according to the present general inventive concept. FIG. 4 is a flow chart illustrating another exemplary embodiment of a method 300 according to the present general inventive concept.

In an alternative exemplary embodiment, the present invention provides for a method 200 of using a two-dimensional barcode having a first data field and a second data field which includes receiving registration information from a location 202, assigning the location a unique identification 204, receiving a greeting information corresponding to the location and the unique identification 206, storing the registration information, the location, the unique identification and the corresponding greeting information within a storage device 208, capturing data from a two-dimensional barcode using an electronic device 210, initiating a software program identified within the first data field of the captured two-dimensional barcode 212, and using the identified software program to execute commands within the second data field of the captured two-dimensional barcode 214.

The two-dimensional barcode may be physically located at the location. The commands may include retrieving the greeting information corresponding to the unique identification identified within the second data field from the storage device.

The commands may further include displaying the greeting information on the electronic device.

The commands further include displaying the greeting information on the electronic device.

In another alternative exemplary embodiment, the present invention provides for a method 300 of using a two-dimensional barcode having a plurality of data fields which includes receiving a user registration information from a user 302, storing the user registration information within a first storage device 304, receiving a product identification information of a product including a unique identification 306, storing the product identification information within a second storage device 308, capturing data from a two-dimensional barcode corresponding to a desired product using an electronic device 310, initiating a software program identified within a first data field of the plurality of data fields 312, using the identified software program to retrieve the product identification information from the second storage device corresponding to the unique identification identified within a second data field of the plurality of data fields 314, retrieving the product identification information corresponding to the captured two-dimensional barcode data 316, and displaying the product identification information corresponding to the desired product on the electronic device 318.

In exemplary embodiments, the two-dimensional barcode may be physically located on the product.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method for managing data using two-dimensional barcodes, the method comprising:
capturing two-dimensional barcode data having a predetermined format, the predetermined format having a first data field, a second data field, and a third data field;
initiating a software program identified in the first data field; and
accessing a server identified in the second data field using data within the third data field.

2. The method for claim 1, wherein the third data field includes at least one of an account identification code, a computer readable code, a user identification code, and a user password.

3. A method of using a two-dimensional barcode having a first data field and a second data field, the method comprising:
receiving registration information from a location;
assigning the location a unique identification;
receiving a greeting information corresponding to the location and the unique identification;
storing the registration information, the location, the unique identification and the corresponding greeting information within a storage device;
capturing data from a two-dimensional barcode using an electronic device;
initiating a software program identified within the first data field of the captured two-dimensional barcode; and
using the identified software program to execute commands within the second data field of the captured two-dimensional barcode.

4. The method of claim 3, wherein the two-dimensional barcode is physically located at the location.

5. The method of claim 3, wherein the commands include retrieving the greeting information corresponding to the unique identification identified within the second data field from the storage device.

6. The method of claim 5, wherein the commands further include displaying the greeting information on the electronic device.

7. The method of claim 4, wherein the commands further include displaying the greeting information on the electronic device.

8. A method of using a two-dimensional barcode having a plurality of data fields, the method comprising:
receiving a user registration information from a user;
storing the user registration information within a first storage device;
receiving a product identification information of a product including a unique identification;
storing the product identification information within a second storage device;
capturing data from a two-dimensional barcode corresponding to a desired product using an electronic device;
initiating a software program identified within a first data field of the plurality of data fields;
using the identified software program to retrieve the product identification information from the second storage device corresponding to the unique identification identified within a second data field of the plurality of data fields; and
displaying the product identification information corresponding to the desired product on the electronic device.

9. The method of claim 8, wherein the two-dimensional barcode is physically located on the product.

10. A method for managing data using two-dimensional barcodes, the method comprising:
capturing two-dimensional barcode data having a predetermined format using a specific software on a mobile device, the predetermined format having a first data field, a second data field, and a third data field, the first data field defining a first URL address,
wherein the specific software stores a plurality of redirect addresses, each redirect address having a table of conditions; and
retrieving data using a redirect address if data within the two-dimensional barcode data matches data within the table of conditions corresponding to the redirect address.

11. The method of claim 10, wherein the specific software retrieves data from a first redirect address stored on the mobile device when data within the two-dimensional barcode data satisfy the conditions corresponding to the first redirect address defined within the table of conditions.
